(19) United States
(12) Patent Application Publication
(10) Pub. No.: US 2024/0158244 A1
(43) Pub. Date: May 16, 2024

(54) PROCESS FOR THE PREPARATION OF SILICATE FROM A PLANT ASH COMPRISING CRYSTALLINE SILICA USING A SALT CONTAINING A MULTIVALENT ANION

(71) Applicant: RHODIA OPERATIONS, Lyon (FR)

(72) Inventors: François Payan, Paris (FR); Youssef Chkounda, Villemomble (FR)

(73) Assignee: RHODIA OPERATIONS, Lyon (FR)

(21) Appl. No.: 18/496,469

(22) Filed: Oct. 27, 2023

(30) Foreign Application Priority Data
Oct. 28, 2022 (EP) 22306641.6
Oct. 28, 2022 (EP) 22306642.4

(51) Int. Cl. C01B 33/32; C01B 33/12

(52) U.S. Cl. CPC C01B 33/325; C01B 33/128

(57) ABSTRACT

The invention relates to a process for producing a silicate from a plant ash comprising crystalline silica. The process comprises reacting said plant ash with a base in the presence of an additive which is a salt comprising a multivalent anion. The invention also relates to a silicate obtainable from said process and to a process for preparing a precipitated silica from said silicate. The invention also concerns a reaction mixture which can be used for said processes.

### CROSS REFERENCE TO RELATED APPLICATIONS

This application claims priority from European application No. 22306641.6 and European application No. 22306642.4, both filed on 28 Oct. 2022, the whole content of these applications being incorporated herein by reference for all purposes.

### TECHNICAL FIELD

The invention relates to a process for producing a silicate, preferably an alkali metal silicate, from a plant ash comprising crystalline silica. The process comprises reacting said plant ash with a base in the presence of an additive which is a salt comprising a multivalent anion. The invention also relates to a silicate obtainable from said process and to a process for preparing a precipitated silica from said silicate. The invention also concerns a reaction mixture to be used in said processes.

### TECHNICAL BACKGROUND

Silicon dioxide (SiO₂), also known as silica, is a silicon compound that is commonly found in nature. Naturally-occurring silica exists both in amorphous and crystalline forms such as cristobalite, tridymite and quartz, the latter being the major constituent of sand.

Quartz sand is frequently employed for the production of silicates, in particular sodium silicates, which can be obtained, for example, by hydrothermal treatment of quartz sand with strong bases such as sodium hydroxide or potassium hydroxide, or by fusion of quartz sand with sodium carbonate at high temperatures of around 1400-1500° C.

Sodium silicates are commonly employed as raw materials for the preparation of precipitated silica, which is a form of synthetic silica in amorphous form.

Both silicates and precipitated silica are highly versatile materials with a variety of applications in the most diverse technological fields, from constructions to detergents, tire, adhesives, food and pharmaceutical industries, and their global demand is constantly increasing.

However, the above-mentioned processes have the major disadvantages that sand, used as raw material, is not a renewable resource over human timescales as its replenishment happens through rocks erosion and weathering processes over geological time.

Moreover, the aforementioned conventional process of manufacturing silica by sand fusion requires a high consumption of energy due to the fact that the reactants need to be heated to elevated temperatures.

It appears thus clear that there remains a need to find a process for producing silicates and silica which is not only more environmentally sustainable but also cost-effective.

A possible renewable source can be envisaged in the ashes derived from the combustion of plants and in particular plant ashes derived from the combustion of silica-rich plants and/or parts thereof such as rice husk.

Rice husk is an agricultural residue of the rice milling industry and is abundant in rice producing countries. Upon burning, about 20% of the weight of the rice husk is converted into ash comprising up to 97 wt. % of silica in addition to carbon impurities and various metals in trace amounts. A portion of the silica contained in the ash is in crystalline form and the main crystalline phase is typically cristobalite.

Similarly, other plant ashes which are particularly rich in silica are those deriving from the combustion of a tree and/or sugar cane, in particular from the combustion of tree wood and/or sugar cane bagasse. Also in this case, the ash can comprise up to 97 wt. % of silica in addition to carbon and metal impurities, and a portion of this silica contained in the ash is in crystalline form, wherein the main crystalline phase is typically quartz.

In view of the high amount of silica contained in these ashes and their intrinsically renewable nature, many efforts have been made to try to extract silica from them as this could represent an economically feasible option for obtaining silicate and precipitated silica.

US 2020/0399134 describes a process for producing a sodium silicate solution from ash of burned organic matter, such rice husk ash, by washing the ash and reacting the rinsed ash in the presence of sodium hydroxide to obtain a solution of sodium silicate.

WO 2017/063901 discloses instead the preparation of a silicate by reacting rice husk ash with a silicate precursor. This document also describes the preparation of precipitated silica from the silicate thus produced.

The preparation of silica from rice husk ash is also described, for example, in WO 2004/073600 which discloses a process for the preparation of precipitated silica by the addition of an acid to a silicate solution obtained by caustic digestion of a biomass ash such as rice husk ash.

One of the criticalities of the processes that use plant ash as starting material, such as rice husk ash, but also, for example, wood ash and/or sugar cane bagasse, is that, as mentioned before, the ash comprises silica which has a crystalline portion. Unlike the amorphous form, which is relatively easily attacked and dissolved when the ash is reacted in alkali conditions (e.g. alkali digestion/caustic digestion), the crystalline portion is much more difficult to dissolve and these processes often lead to low yields of silica conversion or require elevated temperatures. Another issue related to the use of plant ash concerns the fact that, being the ash a complex material, it is generally difficult to obtain a silicate that is easily separable from the rest of impurities as these often remains suspended.

Therefore, there was still the need to develop a novel process for producing silicate and precipitated silica which is environmentally friendly, cost-efficient, and with high yields.

### SUMMARY OF THE INVENTION

The present invention relates to a process for producing a silicate, preferably an alkali metal silicate, from a plant ash, wherein the process comprises a step (a) of reacting:
(i) a plant ash obtained from a combustion of a silica-containing plant part and/or plant, wherein said plant ash comprises crystalline silica;
with
(ii) a base, preferably an alkali metal hydroxide;
   wherein the reaction of step (a) is carried out in a reaction mixture comprising: a dispersing medium, preferably an aqueous dispersing medium, and an additive, wherein said additive is a salt comprising a multivalent anion.

According to an embodiment of the invention, the silicate is obtained in liquid form as a silicate solution, preferably an aqueous silicate solution, and the process further comprises a step (b) of separating the silicate solution obtained after step (a) from impurities deriving from the ash comprising carbon products and metals.

According to another embodiment of the invention, the silicate is obtained in solid form as a solid silicate and the process further comprises, after said step (b), a step (c) of drying the silicate solution obtained after step (b) so as to obtain a silicate in solid form.

Furthermore, the invention relates to a silicate, preferably an alkali metal silicate obtainable in liquid form as a silicate solution by the process comprising step (b) or in solid form as a solid silicate by the process comprising step (c).

Furthermore, the invention relates to a process for preparing a precipitated silica, comprising the steps of:
(I) producing a silicate solution either by the process comprising step (b) or by a process which comprises producing a silicate in solid form by the process comprising step (c) and redispersing the silicate in solid form in a dispersing medium, preferably an aqueous dispersing medium, and
(II) reacting the so-produced silicate solution and, optionally in addition, a silicate solution other than the so-produced silicate solution, NaOH, and/or a secondary silica source, with an acidifying agent to achieve precipitation of silica.

Furthermore, the invention provides a new reaction mixture for producing a silicate, preferably an alkali metal silicate, from a plant ash and/or for preparing a precipitated silica by the processes defined above, comprising:
(i) a plant ash obtained from the combustion of a silica-containing plant part and/or plant, wherein said plant ash comprises crystalline silica;
(ii) a base, preferably an alkali metal hydroxide;
(iii) a dispersing medium, preferably an aqueous dispersing medium, and
(iv) an additive, wherein said additive is a salt comprising a multivalent anion.

The present invention solves the aforementioned problems of the prior art by providing a process for producing a silicate and precipitated silica from a plant ash which allows improving the dissolution of the silica contained in the ash, either in the amorphous or the crystalline form.

Compared to the amorphous form, crystalline silica is more difficult to dissolve and, in normal alkaline digestion processes where the ash is reacted with a base, is only partially dissolved or not dissolved at all unless higher temperatures, and/or longer reaction times are employed. To solve this issue, the inventors conducted several experiments and surprisingly found that the presence of an additive, which is a salt comprising a multivalent anion, within the reaction mixture of the invention, allows improving the dissolution not only of the amorphous portion but also of the crystalline portion of the silica comprised in the plant ash.

Additionally, the invention is particularly advantageous as it allows to obtain a silicate solution which can be effectively separated from the impurities deriving from the ash so to obtain the desired yield and degree of purity.

Furthermore, the invention allows to reduce the crystalline silica content in the resulting waste at the end of the process (carbon cake) thus reducing potentially hazardous waste (if dried).

Furthermore, both the process for producing a silicate and the process for producing a precipitated silica according to the invention are not only environmentally friendly as they employ a plant ash (which is a renewable source) but also economically advantageously because lower temperatures can be used without affecting the overall yield.

### DETAILED DESCRIPTION OF THE INVENTION

Before the issues of the invention are described in detail, the following should be considered:

It is to be understood that this invention is not limited to particular embodiments described, since such embodiments may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise. By way of example, “an additive” means one additive or more than one additive, or “a salt” means one salt or more than one salt.

The terms “comprising”, “comprises”, and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists”, and “consists of”.

Throughout this application, the term “about” is used to indicate that a value includes the standard deviation of error for the device or method being employed to determine the value.

The terms “rice husk” and “rice hull” are used herein interchangeably. The same applies to the terms “rice husk ash” and “rice hull ash”, which are also abbreviated as RHA.

As used herein, the term “average” refers to number average unless indicated otherwise.

As used herein, the terms “% by weight”, “wt.-%”, “.%”, “weight percentage”, or “percentage by weight”, are used interchangeably. The same applies to the terms “% by volume”, “vol.-%”, “vol. %”, “volume percentage”, or “percentage by volume”, or “% by mol”, “mol-%”, “mol. %”, “mol percentage”, or “percentage by mol”.

The recitation of numerical ranges by endpoints includes all integer numbers and, where appropriate, fractions subsumed within that range (e.g. 1 to can include 1, 2, 3, 4 when referring to, for example, a number of elements, and can also include 1.5, 2, 2.75, and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different alternatives, embodiments, and variants of the invention are defined in more detail. Each alternative and embodiment so defined may be combined with any other alternative and embodiment, and this for each variant unless clearly indicated to the contrary or clearly incompatible when the value range of a same parameter is disjoined. In particular, any feature indicated as being preferred or advantageous may be combined with any other feature or features indicated as being preferred or advantageous.

Furthermore, the particular features, structures, or characteristics described in the present description may be combined in any suitable manner, as would be apparent to a person skilled in the art from this disclosure, in one or more embodiments. Furthermore, while some embodiments described herein include some but not other features included in other embodiments, combinations of features of different embodiments are mean to be within the scope of the invention, and form different embodiments, as would be understood by those in the art.

The present invention refers to a process for producing a silicate from a plant ash, wherein the process comprises a step (a) of reacting:
(i) a plant ash obtained from a combustion of a silica-containing plant part and/or plant, wherein said plant ash comprises crystalline silica;
   with
(ii) a base;
   wherein the reaction of step (a) is carried out in a reaction mixture comprising: a dispersing medium and an additive, wherein said additive is a salt comprising a multivalent anion.

According to the invention, said silicate is preferably an alkali metal silicate and said base is preferably an alkali metal hydroxide.

The dispersing medium can be any suitable medium for dispersing the plant ash, the base, and/or the additive. It is preferred that said dispersing medium is an aqueous dispersing medium, more preferably water.

The multivalent anion usually comprises several oxygen atoms. In some embodiments, the multivalent anion is an oxyanion, optionally with one or more proton(s) attached thereto. In some embodiments, the multivalent anion is free of any heteroatom other than oxygen. In some other embodiments, the multivalent anion, possibly an oxyanion or an oxyanion with one or more proton(s) attached thereto, contains one or more heteroatom(s) other than oxygen; the at least one heteroatom is typically an element of group 13, 14 or 15 of Mendeleev's Periodic Table of the Elements, based on new IUPAC system.

The multivalent anion can be selected from the group consisting of carboxylates, phosphate [(PO₄)³⁻], hydrogenophosphate [(HPO₄)²⁻], Pyrophosphate [(P₂O₇)⁴⁻], acid diphosphates [(HP₂O₇)³⁻ and (H₂P₂O₇)²⁻], triphosphate [(P₃O₁₀)⁵⁻], acid triphosphates [(HP₃O₁₀)⁴⁻, (H₂P₃O₁₀)³⁻ and (H₃P₃O₁₀)²⁻], phosphite [(HPO₃)²⁻], pyrophosphite [(H₂P₂O₅)²⁻], carbonate [(CO₃)²⁻], borate [(BO₃)³⁻] and combinations thereof.

According to the invention, carboxylates multivalent anions have typically the general formula

R**(—COO⁻)_{N}

wherein N is an integer greater than or equal to 2, preferably from 2 to 10, more preferably from 2 to 5, still more preferably 2 or 3, and R** is a C₁-C₃₀ N-valent hydrocarbon group with N as defined above, which can optionally be interrupted by one or more heteroatom(s) and/or substituted by one or more functional group(s) other than —COO⁻.

R** may also be substituted by one or more acidic carboxylic acid groups (—COOH); examples of carboxylate multivalent anions substituted by one or more acidic carboxylic acid groups are a monoacid dicarboxylate derived from a tricarboxylic acid (having one —COOH group and two —COO⁻ groups), a monoacid tricarboxylate derived from a tetracarboxylic acid (having one —COOH group and three —COO⁻ groups), a diacid dicarboxylate derived from a tetracarboxylic acid (having two —COOH groups and two —COO⁻ groups) and a combination thereof. Notwithstanding the above, R* is in general free of any acidic carboxylic acid groups (—COOH).

The N-valent hydrocarbon group can be linear, ramified or cyclic. It can be saturated or unsaturated. It can be aliphatic or aromatic.

According to the invention, R** can be a C₁-C₃₀ N-valent saturated (e.g. C₁-C₃₀ N-valent alkanediyl) or unsaturated (e.g. C₁-C₃₀ N-valent alkenediyl or alkynediyl) hydrocarbon group.

Additionally, R** is preferably a C₁-C₂₀ N-valent hydrocarbon group, more preferably C₁-C₁₅ N-valent hydrocarbon group, most preferably C₁-C₁₀ N-valent hydrocarbon group.

Said one or more heteroatom(s) can be selected from the group consisting of O, N, S and combinations thereof.

Said one or more functional group(s) other than —COO⁻ can be selected from the group consisting of —OH, —NH₂, —X wherein X is a halogen atom (including —F, —Cl, —Br, —I and combinations thereof), —C(═O)NH₂, —NO₂, ═N—, —C(═O)— and combinations thereof.

The carboxylates multivalent anions can be dicarboxylates having general formula ⁻OOC—R′−COO⁻, wherein R′ is a C₁-C₃₀ divalent hydrocarbon group which can optionally be interrupted by one or more heteroatom(s) and/or substituted by one or more functional group(s) other than —COO⁻.

Preferably, said group R′ corresponds to group R** as defined above, where N is =2.

Said one or more heteroatom(s) can be selected from the group consisting of O, N, S and combinations thereof.

Said one or more functional group(s) other than —COO⁻ can be selected from the group consisting of —OH, —NH₂, —NO₂, ═N—, —C(═O)— and combinations thereof.

Preferably, said dicarboxylates are selected from:
aliphatic saturated dicarboxylates, preferably aliphatic saturated dicarboxylates selected from the group consisting of oxalate (C₂O₄²⁻), malonate (C₃H₂O₄²⁻), succinate (C₄H₄O₄²⁻), glutarate (C₅H₆O₄²⁻), adipate (C₆H₈O₄²⁻), sebacate (C₁₀H₁₆O₄²⁻) and combinations thereof, more preferably oxalate;
aliphatic unsaturated dicarboxylates, preferably aliphatic unsaturated dicarboxylates selected from the group consisting of butenedioate (C₄H₂O₄²⁻), maleate (C₄H₂O₄²⁻, (2Z)-but-2-enedioate), fumarate (C₄H₂O₄²⁻, (2E)-but-2-enedioate), itaconate (C₅H₄O₄²⁻), glutaconate (C₅H₄O₄²⁻, (E)-pent-2-enedioate) and combinations thereof;
substituted aliphatic dicarboxylates, preferably aliphatic hydroxydicarboxylates such as tartronate (C₃H₂O₅²⁻), malate (C₄H₄O₅²⁻), tartarate (C₄H₄O₆²⁻), or a combination thereof, aliphatic aminodicarboxylates such as aspartate (C₄H₅NO₄²⁻), aliphatic ketodicarboxylates such as mesoxalate (C₃O₅²⁻) and/or oxaloacetate (C₄H₂O₅²⁻), and combinations thereof, more preferably malate; and
aromatic dicarboxylates, preferably aromatic dicarboxylates selected from the group consisting of benzene-1,3-dioate (C₇H₄O₄²⁻), benzene-1,4-dioate (C₇H₄O₄²⁻), o-phthalate (C₈H₄O₄²⁻), isophthalate (C₈H₄O₄²⁻), terephthalate (C₈H₄O₄²⁻) and combinations thereof.

According to the invention, the carboxylates multivalent anions can be tricarboxylates having general formula:

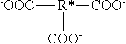

wherein R* is a C₁-C₃₀ trivalent hydrocarbon group which can optionally be interrupted by one or more heteroatom(s) and/or substituted by one or more functional group(s) other than —COO⁻.

Preferably said group R* corresponds to group R* * as defined above, where N is =3.

Said one or more heteroatom(s) can be selected from the group consisting of O, N, S and combinations thereof.

Said one or more functional group(s) other than —COO⁻ can be selected from the group consisting of —OH, —NH₂, —NO₂, ═N—, —C(═O)— and combinations thereof.

Preferably, said tricarboxylates are selected from:
unsubstituted tricarboxylates, including unsubstituted aromatic tricarboxylates [such as trimesate (C₉H₃O₆³⁻)] and unsubstituted aliphatic tricarboxylates, preferably unsubstituted aliphatic tricarboxylates, more preferably propane-1,2,3-tricarboxylate (C₆H₅O₆³⁻) and/or aconitate (C₆H₃O₆³⁻); and
substituted tricarboxylates, preferably aliphatic hydroxytricarboxylates, more preferably aliphatic hydroxytricarboxylates selected from the group consisting of citrate (C₆H₅O₇³⁻), isocitrate (C₆H₅O₇³⁻), oxalosuccinate (C₆H₃O₇³⁻) and combinations thereof, still more preferably citrate.

According to an embodiment of the invention, the carboxylates multivalent anions can be multicarboxylates having general formula as described above, wherein N is greater than 3.

The multicarboxylates can be selected from the group consisting of tetracarboxyalates (N=4) such as ethylenediaminetetraacetate (C₁₀H₁₂N₂O₈⁴⁻), pentacarboxylates (N=5) such as diethylenetriamine pentaacetate

(C₁₄H₁₈N₃O₁₀⁵⁻), polycarboxylate polymers (preferably, aminopolyacetates) and combinations thereof.

According to a preferred embodiment of the invention, the multivalent anion is selected from a dicarboxylate, a tricarboxylate and a combination thereof. More preferably, the multivalent anion is selected from an aliphatic saturated dicarboxylate (preferably, oxalate), an aliphatic hydroxydicarboxylate (preferably, malate), an aliphatic hydroxytricarboxylate (preferably, citrate), and combinations thereof.

According to another preferred embodiment of the invention, the multivalent anion differs from a silicate anion; more preferably, it differs from any silicon-containing anion. Yet, in a special embodiment of the present invention, the multivalent anion is a silicate anion. The silicate anion can be selected from the group consisting of orthosilicate [(SiO₄)₄₋], metasilicate [(SiO₃)²⁻], polymeric metasilicate {[(SiO₃)²⁻]ₙ, wherein n is an integer greater than 1}, pyrosilicate [(Si₂O₇)⁶⁻], hexafluorosilicate [(SiF₆)²⁻], hexahydrosilicate {[Si(OH)₆]²⁻} and combinations thereof. For the avoidance of doubt, in this special embodiment, the additive of concern, which is then a salt comprising a silicate anion, is not produced by reacting the plant ash with the base in the reaction mixture, although its chemical natural and the chemical nature of the silicate produced by reacting the plant ash with the base in the reaction mixture can be identical.

The salt preferably comprises an alkali metal cation, an ammonium cation, or a quaternary ammonium cation of formula NR₄⁺(where R=C₁-C₂₀, preferably C₁-C₁₀, more preferably C₁-C₅ hydrocarbon group), more preferably an alkali metal cation.

It is preferred that said salt comprises a cation selected from the group consisting of Na⁺, K⁺, Cs⁺, Li⁺, Rb⁺, and combinations thereof; more preferably, it is Nat, K⁺or a combination thereof.

Additionally, it is preferred that said salt is sodium citrate (Na₃C₆H₅O₇), potassium citrate (K₃C₆H₅O₇), or a combination thereof.

According to the invention, the reaction mixture can comprise more than one additive as defined above. In other words, the reaction mixture according to the invention can comprise more than one salt comprising a multivalent anion as defined above.

According to the invention, the amount of the additive within the reaction mixture should be significantly above a catalytic amount and should be adapted depending on the level of crystalline silica which is not dissolved by alkaline digestion, i.e., by reaction of the plant ash (i) with the base (ii) and the dispersing medium (iii).

Preferably, the amount of additive within the reaction mixture is of at least 1 g/L, at least 5 g/L, at least 10 g/L or at least 15 g/L, more preferably at least 20 g/L.

It is preferred that the amount of plant ash within the reaction mixture is at least 10 wt. %, at least 15 wt. %, at least 20 wt. %, more preferably at least 22 wt. % by weight based on the total weight of the reaction mixture.

Additionally, it is preferred that the amount of base within the reaction mixture is preferably characterized by a ratio [SiO₂]:[Na₂O] of 2 to 10, more preferably of 3 to 8, even more preferably of 3 to 6, most preferably of 3 to 4.

According to the invention, said reaction mixture can be formed by putting together the plant ash, the base, the dispersing medium, and the additive and/or a precursor of the additive. In fact, it has been found that the additive, which is a salt comprising a multivalent anion, can be advantageously added to the reaction mixture as a salt which is already formed and/or can be formed in-situ by adding, to the reaction mixture, a precursor of the salt, especially an acid comprising a multivalent anion.

Said acid comprising a multivalent anion is the acid equivalent of the multivalent anion mentioned above according to any on the embodiments of the present invention.

Preferably, said acid comprising a multivalent anion is selected from the group consisting of carboxylic acids, phosphoric acid (H₃PO₄), pyrophosphoric acid (H₄P₂O₇), triphosphoric acid (H₅P₃O₁₀), phosphorous acid (H₃PO₃), pyrophosphorous acid (H₄P₂O₅), carbonic acid (CH₂O₃), boric acid (BH₃O₃) and combinations thereof. Preferably, said acid comprising a multivalent anion is a carboxylic acid selected from a dicarboxylic acid, a tricarboxylic acid and a combination thereof.

The dicarboxylic acid can be selected from the group consisting of oxalic acid (C₂H₂O₄), malonic acid (C₃H₄O₄), succinic acid (C₄H₆O₄), glutaric acid (C₅H₈O₄), adipic acid (C₆H₁₀O₄), sebacic acid (C₁₀H₁₈O₄), butenedioic acid (C₄H₄O₄), fumaric acid (C₄H₄O₄, trans-butenedioic acid), maleic acid (C₄H₄O₄, cis-butenedioic acid), itaconic acid (C₅H₆O₄), glutaconic acid (C₅H₆O₄, (E)-Pent-2-enedioic acid), tartronic acid (C₃H₄O₅), malic acid (C₄H₆O₅), tartatic acic (C₄H₆O₆), aspartic acid (C₄H₇NO₄), mesoxalic acid (C₃H₂O₅), oxalaceitc acid (C₄H₄O₅), terephthalic acid (C₈H₆O₄) and combinations thereof. Preferably; it is oxalic acid and/or maleic acid.

The tricarboxylic acid can be selected from the group consisting of tricarballylic acid (C₆H₈O₆), aconitic acid (C₆H₆O₆), trimellitic acid (C₉H₆O₆), citric acid (C₆H₈O₇), isocitric acid (C₆H₈O₇), oxalosuccinic acid (C₆H₆O₇) and combinations thereof; preferably, it is citric acid.

In a special embodiment (corresponding to the special embodiment as above described for the multivalent anion), said acid is at least one silicic acid.

Another possible precursor of the additive is an acid salt comprising a monovalent anion, e.g. sodium hydrogenoxalate (NaHC₂O₄) or sodium dihydrogenophosphate (NaH₂PO₄); as well known to the skilled person, such an acid salt can react with the base, e.g. NaOH, to obtain one or more salt(s) comprising a multivalent anion, e.g. respectively sodium oxalate or at least one of Na₂HPO₄ and Na₃PO₄.

Still another possible precursor of the additive is an anhydride or an oxide of an acid comprising a multivalent anion, e.g. respectively succinic anhydride or carbon dioxide; as well known to the skilled person, when the dispersing medium is an aqueous dispersing medium, such an anhydride or oxide can be converted into the corresponding diacid, e.g. respectively succinic acid or carbonic acid, which itself can react with the base, e.g. NaOH, to obtain a salt comprising a multivalent anion, e.g. sodium succinate or sodium carbonate.

When an acid comprising a multivalent anion, an acid salt comprising a monovalent anion, an anhydride of an acid comprising a multivalent anion, an oxide of an acid comprising a multivalent anion, or a combination thereof is used as a precursor of the additive, it is understood that a sufficient amount of the base must be present in the reaction medium, not only for reacting with the plant ash to produce the silicate but also for reacting with said acid, acid salt, anhydride, oxide or combination thereof and converting it into the additive, namely the corresponding salt of said acid, acid salt, anhydride, oxide or combination thereof.

Preferably the additive and/or a precursor of the additive (especially, an acid comprising a multivalent anion) can be added to the reaction mixture during step (a), and/or to the mixture obtained after a pre-dissolution step (a′) carried out before step (a), so as to form the reaction mixture according to the invention. Said pre-dissolution step (a′) comprises reacting the plant ash (i) in the presence of the base (ii) and of the dispersing medium (iii) and allows at least a partial dissolution of the plant ash. Since the plant ash is a complex material comprising not only crystalline silica but also impurities deriving from the combustion of the plant and/or plant part, it is believed that said pre-dissolution step (a′) can help obtaining an improved dissolution during subsequent step (a) in the presence of the additive and/or the precursor of the additive (especially, an acid comprising a multivalent anion).

According to an embodiment of the invention, the additive and/or a precursor of the additive (especially, an acid comprising a multivalent anion) can be added directly to the ash before step (a′) or step (a), and/or to the plant before combustion.

According to the invention it is preferred that the base (ii) is an alkali metal hydroxide which is selected from the group consisting of NaOH, KOH, LiOH, CsOH, RbOH, NH_{3(aq)} and combinations thereof, and/or a base having the following formula NR ₄⁺OH⁻ (where R=C₁-C₂₀, preferably C₁-C₁₀, more preferably C₁-C₅ hydrocarbon group). More preferably, the base (ii) is NaOH, KOH, or a combination thereof.

Additionally, it is preferred that the silicate which is produced by the invented process is an alkali metal silicate. More preferably, the silicate is sodium silicate, potassium silicate or a combination thereof.

According to an embodiment, step (a) of the process of the invention is carried out at a reaction temperature from 120 to 250° C., preferably from 120 to 230° C., more preferably from 165 to 205° C., most preferably from 170 to 190° C.

According to a particularly preferred embodiment, step (a) of the process of the invention is carried out at a reaction temperature from 120 to 250° C., preferably from 120 to 230° C., more preferably from 200 to 230° C., even more preferably from 205 to 220° C.

Without wishing to be bound to a specific theory or mechanism, it has been found that the process of the invention can be surprisingly and advantageously carried out without the need to use higher temperature normally employed in the processes of the prior art and, in particular, can be carried out at temperatures from 120 to 250° C. It is believed that the presence of the additive, in combination with the other ingredients of the reaction mixture employed in the process of the invention, allows obtaining an improved dissolution of the silica comprised in the plant ash, and in particular of the crystalline portion of said silica, which, with respect to the amorphous portion is more difficult to dissolve by alkaline digestion, namely by simply reacting the ash (i) with the base (ii) and the dispersing medium (iii).

Furthermore, step (a) of the process according to the invention should be carried out for a duration sufficient to achieve dissolution of crystalline silica. Preferably, step (a) is carried out for at least 10 minutes, more preferably more than 30 minutes, even more preferably more than 60 minutes, most preferably more than 90 minutes but, most preferably, less than 240 minutes. More preferably said reaction time is the amount of time for which the reaction temperature of step (a) as mentioned above, is maintained.

According to an embodiment of the invention, the amount of crystalline silica is at least 0.1 wt. %, preferably at least 1 wt. %, more preferably at least 5 wt. %, at least 10 wt. %, at least 20 wt. %, at least 25 wt. %, at least 30 wt. %, at least 40 wt. %, at least 50 wt. %, at least 60 wt. %, at least 70 wt. %, at least 80 wt. %, or at least 90 wt. % based on the total silica (SiO₂) content comprised in the ash.

In an embodiment of the invention, the amount of crystalline silica is preferably from 5 to 50 wt. % based on the total silica (SiO₂) content comprised in the ash.

The crystalline silica according to the invention can comprise a crystalline form selected from the group consisting of quartz, cristobalite, tridymite and combinations thereof.

According to the invention, the silica-containing plant is preferably an angiosperm, more preferably a monocot or eudicot, most preferably a plant belonging to the family selected from the group consisting of Poaceae, Equisetaceae, Cyperaceae, Cucurbitaceae, Cannabaceae, Arecaceae, Brassicaceae, and combinations thereof.

According to an embodiment of the invention, the silica-containing plant is a tree.

Preferably, the tree is selected from the group consisting of pine, oak, birch, elm and combinations thereof.

Preferably, the plant belonging to the family of Poaceae is selected from the group consisting of rice, wheat, sugar cane, bamboo, oat, barley, rye, sorghum, triticale, reed canary grass, reed, corn, miscanthus and combinations thereof.

Preferably, the plant belonging to the family of Equisetaceae is field horsetail.

Preferably, the plant belonging to the family of Cyperaceae is sedge.

Preferably, the plant belonging to the family of Cucurbitaceae is selected from the group consisting of melon, watermelon, squash, cucumber and combinations thereof.

Preferably, the plant belonging to the family of Cannabaceae is hemp.

Preferably, the plant belonging to the family of Arecaceae is palm tree.

Preferably, the plant belonging to the family of Brassicaceae is rapeseed.

According to an embodiment, the silica-containing plant is a plant selected from the group consisting of rice, wheat, rapeseed, barley, bamboo, field horsetail, sedge, watermelon, and combinations thereof.

According to the invention, the plant ash is obtained from a combustion of a silica-containing plant part and/or plant.

Preferably, the part of a silica-containing plant (i.e., silica-containing plant part) is selected from the group consisting of a root, a stem, a leaf, a flower, a fruit, a husk, a culm, a stalk, wood and combinations thereof.

According to the invention, the part of the silica-containing plant can also derive from a processing of the plant, such as straw (e.g. cereals straw), bagasse (e.g. sugar cane bagasse), oil (e.g. palm oil), sawdust (e.g. tree sawdust), and/or pellet (e.g. wood pellet).

Said plant part can be selected from the group consisting of rice husk, rice straw, wheat husk, wheat straw, barley straw, barley husk, sugar cane bagasse, sugar cane leaves, bamboo stem, bamboo leaves, corncob, palm tree oil, miscanthus stalk, miscanthus leaves, sedge leave, watermelon fruit, tree wood and combinations thereof.

In an embodiment of the invention, the silica-containing plant is rice and, preferably, the part of said silica-containing plant is a husk.

According to this embodiment, once burned, the rice husk ash contains a relatively high amount of silica which is preferably of at least 5 wt. %, more preferably at least 10 wt. %, most preferably at least 15 wt. % based on the total weight of the ash.

According to the invention, the combustion of a silica-containing plant part and/or plant is carried out by conventional techniques by burning a part of a plant and/or a plant containing silica.

According to an embodiment, the silica-containing plant part and/or plant can be subjected to at least one pre-treatment. Preferably, said at least one pre-treatment is washing with water, more preferably washing with acidified water.

Preferably, a compound selected from the group consisting of Na₂CO₃, K₂CO₃, NaOH, KOH, and combinations thereof, and/or any other similar compound known to a person skilled in the art, can be added to the silica-containing plant part and/or plant before combustion to reduce the quantity of crystalline silica thus generated. Preferably, if said pre-treatment is carried out, said compound is added to the silica-containing plant part and/or plant after said pre-treatment.

Preferably, the combustion of the silica-containing plant part and/or plant is carried out at a temperature from 300 to 1500° C., preferably from 500 to 1000° C. According to an embodiment, the combustion of the silica-containing plant part and/or plant is carried out at a temperature of at least 700° C., preferably at a temperature from 700° C. to 1000° C., said silica-containing plant part and/or plant preferably containing a compound selected from the group consisting of Na₂CO₃, K₂CO₃, NaOH, KOH, and combinations thereof as described above.

According to another embodiment, the combustion of the silica-containing plant part and/or plant is carried out at a temperature lower than 700° C., preferably at a temperature from 500° C. up to less than 700° C.

According to an embodiment, the plant ash, before being employed in step (a) and/or (a′) of the process of the invention, is subjected to at least one pre-treatment. Preferably, said at least one pre-treatment is or comprises washing with water and/or washing with acidified water; more preferably it is or comprises washing with acidified water.

Additionally, according to an embodiment, a compound selected from the group consisting of Na₂CO₃, K₂CO₃, NaOH, KOH, and combinations thereof, and/or other similar compounds known to a person skilled in the art, can be added to the plant ash before being employed in step (a) and/or (a′). Preferably, if said pre-treatment is carried out, said compound is added to the plant ash after said-pre-treatment.

According to a particularly preferred embodiment of the invention, at least a portion of said crystalline silica is quartz and, more preferably, the majority of said crystalline silica is quartz, wherein the remaining part up to 100 wt. % based on the total crystalline silica content includes cristobalite and/or tridymite.

It is preferred that at least 50 wt. %, of said crystalline silica is quartz based on the total crystalline silica content, preferably at least 60 wt. %, at least 70 wt. %, or at least 80 wt. %, more preferably at least 90 wt. %, even more preferably at least 99 wt. % most preferably about 100 wt. %, based on the total crystalline silica content.

According to a particularly preferred embodiment of the invention, the crystalline silica consists essentially of quartz. In this embodiment, the crystalline silica comprises only trace amounts of cristobalite and/or tridymite.

According to an embodiment of the invention, it is preferred that the amount of quartz is of at least 0.1 wt. %, preferably at least 1 wt. % more preferably at least 5 wt. %, at least 10 wt. %, at least 20 wt. %, at least 25 wt. %, at least 30 wt. %, at least 40 wt. %, at least 50 wt. %, at least 60 wt. %, at least 70 wt. %, at least 80 wt. %, or at least 90 wt. % based on the total silica (SiO₂) content comprised in the ash. In an embodiment of the invention, the amount of quartz comprised within the plant ash is preferably from 5 to 50 wt. % based on the total silica (SiO₂) content comprised in the ash.

According to any one of the preferred embodiments of the invention wherein at least a portion of said crystalline silica is quartz, and, preferably wherein the majority of said crystalline silica is quartz, step (a) of the process of the invention is preferably carried out at a reaction temperature from 200 to 230° C., more preferably from 205 to 220° C.

Additionally, according to the above-mentioned embodiments wherein at least a portion of said crystalline silica is quartz, and, preferably wherein the majority of said crystalline silica is quartz, it is preferred that the silica-containing plant is selected from the group consisting of a tree, sugar cane, and combinations thereof.

Preferably, the tree is selected from the group consisting of pine, oak, birch, elm and combinations thereof.

Preferably, the part of a silica-containing plant (i.e., silica-containing plant part) is wood so that said plant part is tree wood.

The part of the silica-containing plant can also derive from a processing of the plant, such as bagasse (e.g. sugar cane bagasse), sawdust (e.g. tree sawdust), and/or pellet.

More preferably, said silica-containing plant part is wood tree and/or sugar cane bagasse.

According to this embodiment, once burned, the wood tree ash and/or sugar cane bagasse ash contain a relatively high amount of silica which is preferably of at least 5 wt. %, more preferably at least 10 wt. %, most preferably at least 15 wt. % based on the total weight of the ash.

According to the invention, the silicate is preferably in the form of a silicate solution, more preferably an aqueous silicate solution, and the process of the invention can further comprise, after step (a) as described above, a step (b) of separating the silicate solution obtained after step (a) from the impurities deriving from the ash comprising carbon products and metals.

Said metals are for example metals (and/or metalloids) selected from the group consisting of metals of the boron group (in particular B and/or Al), alkali metals (in particular K), alkaline earth metals (in particular Ca and/or Mg), transition metals (in particular at least one of Fe, Mn, Ni, Ti and Zn) and combinations thereof.

According to an embodiment said impurities deriving from the ash can comprise further chemical elements selected from the group consisting of pnictogens (in particular P and/or As), halogens (in particular Cl), and a combination thereof.

According to the invention, said impurities can be present within the silicate solution as undissolved solids and/or in solvated form.

According to another embodiment, the silicate is in the form of a solid silicate and the process of the invention further comprises, after step (b), a step (c) of drying the silicate solution obtained after step (b) so as to obtain a silicate in solid form.

Preferably, the drying of the silicate solution obtained after step (b) is carried out by a conventional drying technique.

Said conventional drying technique is preferably selected from the group consisting of turbine drying, spin-flash drying, atomization, spray-drying and combinations thereof.

Additionally, it is preferred that said conventional drying technique is carried out in the absence of oxygen and/or in a short time to avoid oxidation and degradation of the product.

The invention further relates to a silicate, preferably an alkali metal silicate, obtainable in liquid form as a silicate solution, by the process described above comprising step (b). Preferably said silicate solution is an aqueous silicate solution.

Preferably, said silicate solution is a solution characterized by a silicate content at least 5 wt. %, more preferably at least 10 wt. %, even more preferably at least 15 wt. %, most preferably at least 20 wt. %, even most preferably at least 22 wt. % by weight based on the total weight of the solution.

Additionally, it is preferred that said silicate solution is a solution characterized by a ratio SiO₂]: [Na₂O] of 2 to 10, more preferably of 3 to 8, even more preferably of 3 to 6, most preferably of 3 to 4.

Without wishing to be bound to a specific theory, it has been found that, when the silicate solution is employed for the production of precipitated silica, said ratio allows to advantageously have an efficient silica synthesis as it leads to a good yield, defined structure and limited salt generation.

The invention further relates to a silicate, preferably an alkali metal silicate, obtainable in solid form as a solid silicate by the process described above comprising step (c).

Preferably said solid silicate is characterized by a ratio [SiO₂]: [Na₂O] of 2 to 10, more preferably of 3 to 8, even more preferably of 3 to 6, most preferably of 3 to 4.

Additionally, it is preferred that said solid silicate is characterized by a humidity of at most 10%.

More preferably, said solid silicate is characterized by a granulometry of at least 100 μm.

The invention also concerns a process for preparing a precipitated silica, comprising the steps of:
(I) producing a silicate solution either by the process described above comprising step (b) or by a process which comprises producing a silicate in solid form by the process described above comprising step (c) and redispersing the silicate in solid form thus obtained in a dispersing medium; and
(II) reacting the so-produced silicate solution and, optionally, in addition, a silicate solution other than the so-produced silicate solution, NaOH, and/or a secondary silica source, with an acidifying agent to achieve precipitation of silica.

Preferably, said dispersing medium is an aqueous dispersing medium, more preferably water, and the silicate solution obtained after step (I) to be employed in step (II) is an aqueous silicate solution.

According to an embodiment of the invention, step (II) comprises adding to the silicate solution produced according to step (I), i.e. the so-produced silicate solution, a silicate solution other than the so-produced silicate solution, NaOH, and/or a secondary silica source to adjust the [SiO₂]:[Na₂O] ratio of the silicate and, in turn, of the final precipitated silica.

According to the invention, the silicate solution other than the so-produced silicate solution is a silicate solution produced by any conventional process other than the process of the present invention.

According to the invention, said secondary silica source is a silica produced by any conventional process other than the process of the present invention and/or naturally occurring silica. Preferably, said secondary silica source is amorphous silica.

The acidifying agent can be a mineral acid (preferably, a mineral acid selected from the group consisting of sulfuric acid (H₂SO₄), hydrochloric acid (HCl), nitric acid (HNO₃), phosphoric acid (H₃PO₄) and combinations thereof), an organic acid (preferably, an organic acid selected from the group consisting of: acetic acid, formic acid, carbonic acid, and combinations thereof) or a combination thereof.

Furthermore, the invention relates to a reaction mixture for producing a silicate, preferably an alkali metal silicate, from a plant ash by the process as defined above comprising step (a) (possibly steps (a) and (b), possibly steps (a), (b), and (c)), and/or for preparing a precipitated silica by the process as defined above comprising steps (I) and (II) (possibly, steps (I), (II) and (III)).

The reaction mixture comprises:
(i) a plant ash obtained from the combustion of a silica-containing plant part or plant, wherein said plant ash comprises crystalline silica;
(ii) a base;
(iii) a dispersing medium; and
(iv) an additive, wherein said additive is a salt comprising a multivalent anion.

Preferably, the plant ash (i), the base (ii), the dispersing medium (iii) and the additive (iv) are as described above according to any one of the embodiments of the present invention.

The present invention will now be illustrated by the following examples, which are not intended to be limiting.

### Examples

### Materials and Methods

All starting materials used in the examples are commercially available. For examples 1-4, a rice husk ash (RHA) having the following characteristics, was employed:
Silica content as measured by Assay purity method: 83.1% over total sample;
Cristobalite content as measured by XRD: 40% over total SiO₂ content;
Carbon content as measured by Carbon/sulfur Analysis: 13.5% over total SiO₂ content.

### Determination of the Content of Cristobalite and Carbon

The determination of the content of cristobalite fraction in each sample was performed with the following procedure, which was divided in two parts: the first one was dedicated to the creation of the calibration curve, while the second part was dedicated to the preparation of the samples, the analysis, and the calculation of the cristobalite content by XRD.

### XRD Analyzer

The diffractometer employed for the experiments was a X'Pert Pro from Malvern-Panalytical with the following configuration:

Copper X-ray tube, reflection, Bragg-Brentano configuration, Bragg-Brentano HD mirror, ⅛° divergence slit, 4 mm mask, 0.02 rad front Soller slit, ¼° front anti-scattering slit, 0.02 rad rear Soller slit, ¼° rear anti-scattering slit, X Celerator detector, 1 rotation of the sample holder per second.

### Calibration Curve

The standard samples employed for the calibration curve were prepared with the following raw materials:
Cristobalite provided by Solvay (no 22MAU302), 66.6 wt %+/−2.5 wt % pure. It also contains tridymite and amorphous silica
Amorphous silica provided by Solvay (no 19STD078)
α-Al₂O₃ (purity >99%)
   9 samples with different cristobalite amounts and constant α-Al₂O₃ amounts (20 wt %) were prepared as shown in Table 1 below. The following steps were followed to prepare each sample:
30 minutes of mixing in a Turbula shaker;
Hand grinding of the powder with agate mortar and pestle;
30 minutes of mixing in a Turbula shaker.

TABLE 1

| | Mass of | | | | | |
|---|---|---|---|---|---|---|
| | amorphous | | | Mass | | |
| | silica | Mass of | wt % | of α- | Total | Wt % |
| | 19STD078 | 22MAU302 | cristo- | Al₂O₃ | mass | α- |
| | (g) | (g) | balite | (g) | (g) | Al₂O₃ |
| Sample | 0 | 1.6 | 66 | 0.40 | 2.00 | 20.00 |
| 1 | | | | | | |
| Sample | 0.5 | 1.1 | 45.375 | 0.40 | 2.00 | 20.00 |
| 2 | | | | | | |
| Sample | 0.7 | 0.9 | 37.125 | 0.40 | 2.00 | 20.00 |
| 3 | | | | | | |
| Sample | 0.9 | 0.7 | 28.875 | 0.40 | 2.00 | 20.00 |
| 4 | | | | | | |
| Sample | 1.1 | 0.5 | 20.625 | 0.40 | 2.00 | 20.00 |
| 5 | | | | | | |
| Sample | 1.25 | 0.35 | 14.4375 | 0.40 | 2.00 | 20.00 |
| 6 | | | | | | |
| Sample | 1.4 | 0.2 | 8.25 | 0.40 | 2.00 | 20.00 |
| 7 | | | | | | |
| Sample | 1.5 | 0.1 | 4.125 | 0.40 | 2.00 | 20.00 |
| 8 | | | | | | |
| Sample | 1.55 | 0.05 | 2.0625 | 0.40 | 2.00 | 20.00 |
| 9 | | | | | | |

For each of the 9 samples, 3 XRD sample holders of 16 mm diameter were prepared with back loaded sample holders.

Each XRD sample holder was analyzed from 20=33° to 40° at 200 seconds per step, step size 0.017°.

The HighScore Plus 4.8 software was used to measure the area of the peaks at 35.14° for the Al₂O₃ and the combined areas of the peaks at 36.08° and 38.38° for the cristobalite.

The calibration curve area ratio between cristobalite peaks and Al₂O₃ peaks was established as function of the weight percentage of cristobalite in the samples.

### Preparation of the Samples and Quantification

For each measure, two preparations were done to ensure representativeness of the quantification following the same procedure described below. 1.2 g of the sample was weighed in a glass vial and 0.3 g of α-Al₂O₃ are added. The following steps were followed to ensure an homogeneous mixing:
30 minutes of mixing in a Turbula shaker;
Hand grinding of the powder with agate mortar and pestle;
30 minutes of mixing in a Turbula shaker.

For each preparation, 16 mm diameter back loaded XRD sample holders were charged and analyzed following the following analytical method; 20=33° to 40° at 200 seconds per step, step size 0.017°, Copper X-ray tube, reflection, Bragg-Brentano configuration, Bragg-Brentano HD mirror, ⅛° divergence slit, 4 mm mask, 0.02 rad front Soller slit, ¼° front anti-scattering slit, 0.02 rad rear Soller slit, ¼° rear anti-scattering slit, X Celerator detector, 1 rotation of the sample holder per second. The HighScore Plus 4.8 software was used to measure the area of the peaks.

The ratio of the combined area of the 2 cristobalite peaks (at 36.08° and) 38.38° and the area of the Al₂O₃ peak at 35.14° was used to determine the cristobalite content by using the calibration curve.

### Carbon/Sulfur Analysis

A 200 mg sample was analyzed in Horiba EMIA 320-V2. Lecocel®, iron and tin balls are used as combustion accelerators. CS26-3.19% was used to calibrate the sensor.

### Assay Purity Analysis

1 g of sample was ignited in a tared platinum dish at 1000° C. for 1 hour, cooled in a desiccator and weighed. The resulting solid was wet with water, 10 mL of hydrofluoric acid were added in small increments. The mixture was then evaporated in a steam bath to dryness and then cooled. 10 mL of hydrofluoric and 0.5 mL of sulfuric acid were added and then evaporated to dryness. The temperature was then slowly increased until all of the acids were volatilized. The sample was then ignited at 1000° C., cooled in a desiccator and then weighed. The ratio between the difference of the final weight and the weight of the initially ignited portion on the one hand and the weight of the original sample on the other hand represented the weight percentage of SiO₂.

### Potentiometry

A Titrando 808 was used in order to determine the weight ratio (Rp) [% weight (SiO₂)/% weight (Na₂O)]. The device was equipped with a reference electrode Ag/AgCl in KC13M and a working electrode in tungsten. Each Rp was measured in duplicate and the Rp values were the average between the two measurements.

0.5 g of sample was weighed and completed with 30 mL of demineralized water. The titration solution was a 0.1N HCl solution. The volume V1 (mL) was determined as the equivalence of the titration. After the equivalence, 0.5 mL of titration solution was added.

Afterward, 50 mL of KF solution (50 g/l of KF in a water/ethanol (50/50) solution) was added and allowed to react for 3 minutes. Then, 15 mL of 0.1N HCl solution was added. The excess of HCl was titrated by a NaOH 1N solution and the volume V2 (mL) was the equivalent point of the titration.

The Rp was then calculated following the formula below:

Rp=(0.31*V1)/(1.5(15*1−V2*1)+(0.5*0.1))

### Example 1—Comparative Example without any Additive

In a stirred PARR combustion bomb the following reagents were introduced: 50 mL of NaOH solution at 104 g/L and 16.4 g of RHA. The PARR combustion bomb was then introduced in an oven. The temperature was raised up to 180° C. with a ramp of 1° C./min. Once the temperature was reached, the mixture was left for 1 hour at 180° C. and then cooled down until room temperature was reached. The solution obtained was centrifuged at 4500 tr/min for 35 minutes to separate the residual solid and the solution. The surnatant was then taken for the analysis of the Rp by potentiometry technique. The results are shown in Table 2 below.

### Example 2—Use of Potassium Citrate (Formed In-Situ) as the Additive According to the Present Invention

In a stirred PARR combustion bomb the following reagent were introduced: 50 mL of NaOH at 104 g/L, 2.7 g of citric acid, 2.35 g of KOH, and 16.4 g of RHA. The PARR combustion bomb was then introduced in an oven. The temperature was raised up to 180° C. with a ramp of 1° C./min. Once the temperature was reached, the mixture was left for 1 hour at 180° C. and then cooled down until room temperature was reached. The solution obtained was centrifuged at 4500 tr/min for 35 minutes to separate the residual solid and the solution. The surnatant was then taken for the analysis of the Rp by potentiometry technique. The results are shown in Table 2 below.

### Example 3—Use of Sodium Citrate as the Additive According to the Present Invention

In a stirred PARR combustion bomb the following reagent were introduced: 11.99 of NaOH at 30% in mass, 1.54 g of sodium citrate (Na₃C₆H₅O₇), 11.57 g of RHA, and 24.92 g of deionized water. The PARR combustion bomb was then introduced in an oven. The temperature was raised up to 180° C. with a ramp of 1° C./min. Once the temperature was reached, the mixture was left for 1 hour at 180° C. and then cooled down until room temperature was reached. The solution obtained was centrifuged at 4500 tr/min for 35 minutes to separate the residual solid and the solution. The surnatant was then taken for the analysis of the Rp by potentiometry technique. The results are shown in Table 2 below.

### Example 4 Comparative Example with KCl as an Additive

In a stirred PARR combustion bomb the following reagent were introduced: 50 mL of NaOH at 104 g/L, 0.955 g of KCl, and 16.4 g of RHA. The PARR combustion bomb was then introduced in an oven. The temperature was raised up to 180° C. with a ramp of 1° C./min. Once the temperature was reached, the mixture was left for 1 hour at 180° C. and then cooled down until room temperature was reached. The solution obtained was centrifuged at 4500 tr/min for 35 minutes to separate the residual solid and the solution. The surnatant was then taken for the analysis of the Rp by potentiometry technique. The results are shown in Table 2 below.

### Results

The results obtained with each experiment performed according to Examples 1-4 are shown in Table 2 below.

“Rp target” means the theoretical Rp (SiO₂/Na₂O) in weight based on the quantity of NaOH wt. % and SiO₂ wt. % (from RHA) introduced.

“Rp” is the measured ratio by potentiometric technique.

TABLE 2

| | | | Yield | Max yield in case of |
|---|---|---|---|---|
| | Rp | | (Rp measured/ | non-crystalline silica |
| Example | target | Rp | Rp target) | digestion |
| 1 | 3.4 | 1.59 | 47% | 60% |
| 2 | 3.4 | 3.16 | 93% | 60% |
| 3 | 3.4 | 2.7 | 79% | 60% |
| 4 | 3.4 | 1.63 | 48% | 60% |

Example 1 (for comparison purposes) showed that at a reaction temperature of 180° C., without any additive, crystalline silica cannot dissolved. Example 4 (also for comparison purposes) demonstrated that not all salts are suitable additives for improving the dissolution of crystalline silica: the use of a salt comprising a monovalent anion, such as KCl, as additive, did not lead to the effective dissolution of crystalline silica.

On the contrary, the use of a salt comprising a multivalent anion, such as potassium or sodium citrate, according to the present invention (as shown in Examples 2 and 3), led to a much higher Rp for the same reaction temperature of 180° C. and to a significant increase in the SiO₂ dissolution yield up to >79%. This clearly showed that the use of an additive according to the process of the present invention, greatly improves the dissolution level of crystalline silica even at lower temperatures such as 180° C.

1. A process for producing a silicate from a plant ash, wherein the process comprises a step (a) of reacting:
(i) a plant ash obtained from a combustion of a silica-containing plant part and/or plant, wherein said plant ash comprises crystalline silica;
with
(ii) a base;
wherein the reaction of step (a) is carried out in a reaction mixture comprising a dispersing medium and an additive, wherein said additive is a salt comprising a multivalent anion.

2. The process according to claim 1, wherein the silicate is an alkali metal silicate.

3. The process according to claim 1, wherein the base is an alkali metal hydroxide.

4. The process according to claim 1, wherein the dispersing medium is an aqueous dispersing medium.

5. The process according to claim 1, wherein the plant ash is rice husk ash.

6. The process according to claim 1, wherein the crystalline silica comprises a crystalline form selected from the group consisting of quartz, cristobalite, tridymite and combinations thereof.

7. The process according to claim 1, wherein the amount of crystalline silica is at least 30 wt. % based on the total SiO₂ content comprised in the ash.

8. The process according to claim 1, wherein step (a) of the process of the invention is carried out at a reaction temperature from 120 to 250° C.

9. The process according to claim 1, wherein the multivalent anion is an oxyanion, optionally with one or more proton(s) attached thereto.

10. The process according to claim 1, wherein the multivalent anion is selected from a dicarboxylate, a tricarboxylate and a combination thereof.

11. The process according to claim 1, wherein said salt comprises an alkali metal cation, an ammonium cation, or a quaternary ammonium cation of formula NR₄⁺where R=C₁-C₂₀ hydrocarbon group, or a combination thereof.

12. The process according to claim 1, wherein said salt is sodium citrate (NA₃C₆H₅O₇), potassium citrate (K₃C₆H₅O₇), or a combination thereof.

13. The process according to claim 1, wherein said reaction mixture is formed by putting together the plant ash, the base, the dispersing medium, and the additive and/or an acid comprising a multivalent anion.

14. The process according to claim 1, wherein the silicate is in the form of a silicate solution and wherein the process further comprises a step (b) of separating the silicate solution from the impurities deriving from the ash, comprising carbon products and metals.

15. The process according to claim 14, further comprising a step (c) of drying the silicate solution obtained after step (b) so as to obtain a silicate in solid form.

16. A silicate obtainable in liquid form as a silicate solution by the process according to claim 14.

17. A silicate obtainable in solid form as a solid silicate by the process according to claim 15.

18. A process for preparing a precipitated silica, comprising the steps of:
(I) producing a silicate solution by the process according to claim 14, and
(II) reacting the so-produced silicate solution and, optionally in addition, a silicate solution other than the so-produced silicate solution, NaOH, and/or a secondary silica source, with an acidifying agent to achieve precipitation of silica.

19. A process for preparing a precipitated silica, comprising the steps of:
(I) producing a silicate solution by a process which comprises producing a silicate in solid form by the process according to claim 15 and redispersing the silicate in solid form in a dispersing medium, and
(II) reacting the so-produced silicate solution and, optionally in addition, a silicate solution other than the so-produced silicate solution, NaOH, and/or a secondary silica source, with an acidifying agent to achieve precipitation of silica.

20. A reaction mixture for producing a silicate from a plant ash by the process as defined in claim 1, said reaction mixture comprising:
(i) a plant ash obtained from the combustion of a silica-containing plant part and/or plant, wherein said plant ash comprises crystalline silica;
(ii) a base;
(iii) a dispersing medium;
and
(iv) an additive, wherein said additive is a salt comprising a multivalent anion.
